(19) United States
(12) Patent Application Publication
(10) Pub. No.: US 2006/0279265 A1
(43) Pub. Date: Dec. 14, 2006

(54) Communication system for communications carried over power lines

(75) Inventor: Yasuaki Hori, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Denki Kabushiki Kaisha, Tokyo (JP)

(21) Appl. No.: 11/251,856

(22) Filed: Oct. 18, 2005

(30) Foreign Application Priority Data
Jun. 9, 2005 (JP) 2005-169970

(51) Int. Cl. G05F 1/00

(52) U.S. Cl. 323/280

(57) ABSTRACT

An over-power line communication system has a low impedance circuit unit, which is connected between the power lines, first signal couplers, which are set on the first communication device side to the low impedance circuit unit to electromagnetically couple the power lines with one of signal lines, second signal couplers, which are set on the second communication device side to the low impedance circuit unit to electromagnetically couple the power lines with the other of the signal lines, and an amplifier, which receives transmission signals taken out onto one of the signal lines by the first signal couplers, amplifies the received transmission signals, and sends the amplified signals to the other of the signal lines. The transmission signals amplified and then sent to the other of the signal lines are injected to the power lines by the second signal couplers.

### BACKGROUND OF THE INVENTION

1. Field of the Invention

The present invention relates to a communication system for over-power line communications where power lines serve as transmission paths. More specifically, the present invention relates to a relay amplifying device of an over-power line communication system that is installable by inserting elements in parallel to power lines.

2. Description of Related Art

In relay amplification along a normal communication path, it is easy to separate reception signals from transmission signals, and oscillations caused by transmission signals encroaching on reception signals can be avoided by separating the two from each other. However, in over-power line communication systems which use power lines as transmission paths, it is difficult to separate reception signals from transmission signals physically. Over-power line communication systems therefore prevent the oscillations by inserting elements in series with power lines and thus attenuating transmission signals in frequency range between the transmitting end and the receiving end.

FIG. 5 is a block diagram showing a configuration of a relay amplifying device in a conventional over-power line communication system. FIG. 6 is a circuit example diagram for high impedance circuit units A, which are inserted in series with power lines in the relay amplifying device of the over-power line communication system shown in FIG. 5. The relay amplifying device of the conventional over-power line communication system in FIG. 5 has a block filter 1, which is connected to power lines 10, modems 2a and 2b, a logical processing unit 3, a power supply circuit 4, and a power supply filter 6. The block filter 1 is composed of four high impedance circuit units A and a low impedance circuit unit B. This over-power line communication system uses the high impedance circuit units A and the low impedance circuit unit B to attenuate transmission signals between the transmitting end and the receiving end and to thereby avoid the oscillations (see JP 61-102833 A, for example).

A relay amplifying device of a conventional over-power line communication system as the one described above attenuates transmission signals between the transmitting end and the receiving end by inserting elements (high impedance circuit units A) in series with power lines. However, inserting elements in series with power lines means that the power lines have to stop feeding electric power during installation of such a relay amplifying device. Accordingly, this type of relay amplifying device cannot be installed easily.

### SUMMARY OF THE INVENTION

The present invention has been made to solve the above problem, and an object of the present invention is therefore to provide a relay amplifying device of an over-power line communication system that can be installed without stopping power lines from feeding electric power by eliminating elements inserted in series with the power lines.

According to an aspect of the present invention, there is provided an over-power line communication system including: first and second communication devices connected to each other by two or more parallel power lines; and a relay amplifying device placed between the first and second communication devices, for amplifying signals inputted from one of the first communication device and the second communication device after transmission through the power lines, and sending the amplified signals to the other one of the first communication device and the second communication device, the relay amplifying device including: an amplifier for amplifying inputted signals and outputting amplified signals; first signal couplers for electromagnetically coupling a first signal line, which is connected to the amplifier, with the power lines on the first communication device side; second signal couplers for electromagnetically coupling a second signal line, which is connected to the amplifier, with the power lines on the second communication device side; and a low impedance circuit unit connected between sections of the power lines that are between the first and second signal couplers.

An over-power line communication system according to the present invention makes a relay amplifying device installable without stopping power lines from feeding electric power by eliminating from the relay amplifying device elements that are inserted in series with the power lines. Another effect is that the present invention is applicable to a power line that has a large current capacity.

### BRIEF DESCRIPTION OF THE DRAWINGS

In the accompanying drawings:

FIG. 1 is a block diagram showing a configuration of an over-power line communication system according to a first embodiment of the present invention;

FIG. 2 is a block diagram showing a configuration of an amplifier of FIG. 1;

FIG. 3 is a perspective view showing how signal couplers of FIG. 1 couple lines;

FIG. 4 is a block diagram showing a configuration of an over-power line communication system according to a second embodiment of the present invention;

FIG. 5 is a block diagram showing a configuration of a conventional over-power line communication system; and

FIG. 6 is a diagram showing a circuit example for high impedance circuit units A of FIG. 5.

### DETAILED DESCRIPTION OF THE PREFERRED EMBODIMENTS

### First Embodiment

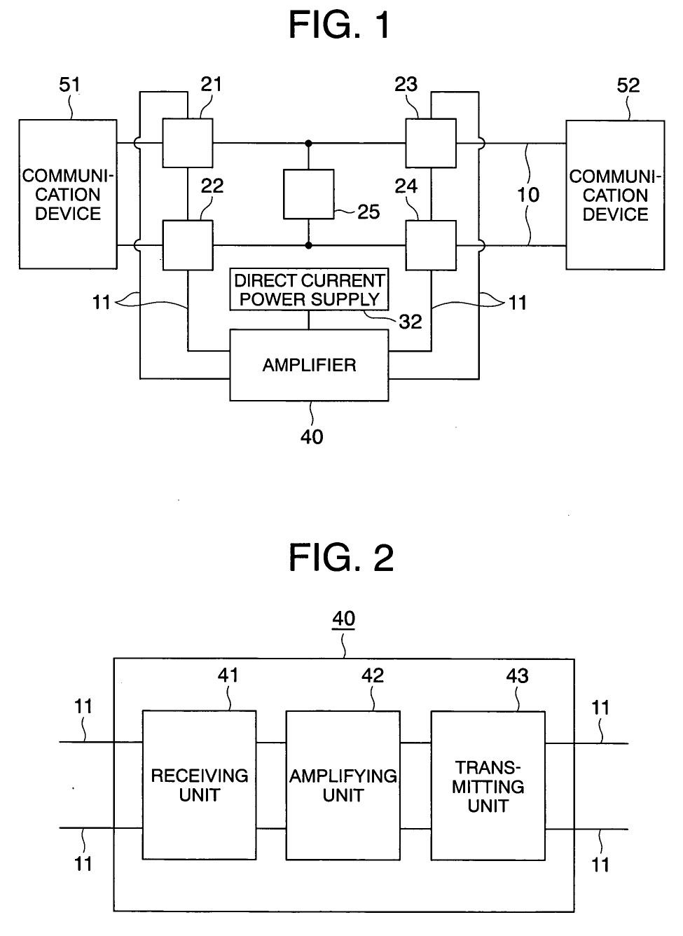

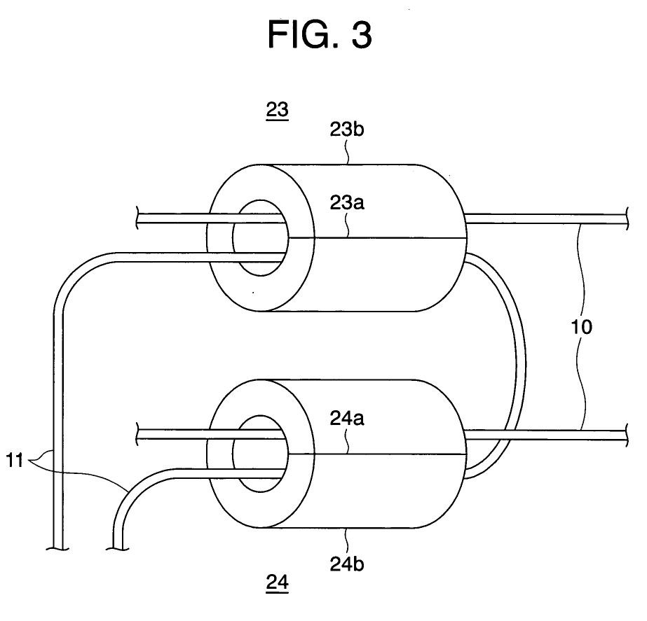

A description is given with reference to FIGS. 1 to 3 on an over-power line communication system according to a first embodiment of the present invention. FIG. 1 is a block diagram showing a configuration of the over-power line communication system according to the first embodiment of the present invention. FIG. 2 is a block diagram showing a configuration of an amplifier of FIG. 1. FIG. 3 is a perspective view showing how signals couplers of FIG. 1 couple lines. In FIGS. 1 to 3, the same reference symbol denotes the same or corresponding component.

In FIG. 1, a relay amplifying device of the over-power line communication system according to the first embodiment has four signal couplers 21, 22, 23, and 24, which electromagnetically couple power lines 10 with signal lines 11 between communication devices 51 and 52, a low impedance circuit unit 25, which is a capacitor or the like having an impedance value of a few ohm (Ω) or lower and connected between the two power lines 10, an amplifier 40, which amplifies transmission signals, and a direct current power supply 32, which is a battery or the like for supplying the amplifier 40 with a given level of voltage.

In FIG. 2, the amplifier 40 has a receiving unit 41, which is connected to one of the signal lines 11, an amplifying unit 42, which is connected to the receiving unit 41, and a transmitting unit 43, which is connected to the amplifying unit 42 and to the other of the signal lines 11. For a simpler explanation, FIG. 2 shows an example of a unidirectional amplifier. However, the amplifier 40 can be bidirectional if, for example, a transmitting unit is connected in parallel to the receiving unit 41 and a receiving unit is connected in parallel to the transmitting unit 43. The power for the amplifier 40 may be supplied from the direct current power supply 32, which is a battery or the like of fixed voltage, or from the power lines 10 as will be described later in a second embodiment.

FIG. 3 illustrates electromagnetic coupling between the power lines 10 and one of the signal lines 11 by the signal couplers 23 and 24 shown in FIG. 1. The signal coupler 23 is made from a ferrite core 23b, which is hollow in its axial center and has a gap 23a. Similarly, the signal coupler 24 is made from a ferrite core 24b, which is hollow in the axial center and has a gap 24a. Though not shown in the drawing, the signal couplers 21 and 22 electromagnetically couple the power lines 10 and one of the signal lines 11 in the same way the signal couplers 23 and 24 do.

The signal couplers 21 to 24 made from the ferrite cores 21b to 24b are wrapped around the power lines 10 and the signal lines 11 coming out of the amplifier 40 are threaded through the hollow signal couplers 21 to 24 (ferrite cores 21b to 24b), to thereby couple the signal lines 11 with the power lines 10 electromagnetically. In order to avoid magnetic saturation from the electric current of the power lines 10, the signal couplers 21 to 24 are made small in size by opening the gaps 21a to 24a in the ferrite cores 21b to 24b as described above, and by setting the frequency range of carrier wave signals to 1 MHz or more and 50 MHz or less.

Described next with reference to the drawings is the operation of the relay amplifying device of the over-power line communication system according to the first embodiment.

The basic operation of this relay amplifying device is as follows. For instance, some of transmission signals sent from the communication device 51 over the power lines 10 are taken out onto one of the signal lines 11 through electromagnetic coupling by the signal couplers 21 and 22. The rest of the transmission signals continue to travel over the power lines 10 toward the communication device 52, but do not go further than the low impedance circuit unit 25 (the side of the communication device 52) since the signals are attenuated by the low impedance circuit unit 25. The same applies to the reverse transmission, namely, transmission from the communication device 52 to the communication device 51.

The receiving unit 41 in the amplifier 40 receives transmission signals that are taken out onto one of the signal lines 11 by the signal couplers 21 and 22, and the amplifying unit 42 amplifies the transmission signals at a given amplification ratio. The amplified transmission signals are sent to the other of the signal lines 11 by the transmitting unit 43, and injected to the power lines 10 through electromagnetic coupling by the signal couplers 23 and 24. The transmission signals amplified and then injected to the power lines 10 travel toward the communication device 51 and toward the communication device 52, but the transmission signals that are propagated toward the communication device 51 do not go further than the low impedance circuit unit 25 (the side of the communication device 51) since they are attenuated by the low impedance circuit unit 25.

With the signal couplers 21 to 24 magnetically coupling the power lines 10 and the signal lines 11, signals do not travel over the signal lines 11 unless electric current flows through the power lines 10. On the other hand, signals do not travel over the power lines 10 unless electric current flows through the signal lines 11. The transmission signals that are injected into the power lines 10 from the transmitting unit 43 in the amplifier 40 via the other of the signal lines 11 and the signal couplers 23 and 24 are divided into two directions, toward the communication device 51 (toward the receiving unit 41) and toward the communication device 52 but, as described above, the transmission signals distributed to the side of the receiving unit 41 flow into the low impedance circuit unit 25, which is inserted between the power lines 10, before reaching the receiving unit 41.

In over-power line communications where the power lines 10 serve as transmission paths, the carrier wave frequency of transmission signals is set to 1 MHz or more and 50 MHz or less, the power lines 10 are coupled with the signal lines 11 through electromagnetic coupling, and transmission signals are attenuated between the transmitting end and the receiving end by the low impedance circuit unit 25 which is a capacitor or the like inserted between the power lines 10.

With the power lines 10 and the signal lines 11 coupled electromagnetically, signals are not coupled unless electric current flows. As described above, an element (capacitor or the like) having low enough impedance in the frequency range that is used in over-power line communications is inserted in the amplifier 40 between the transmitting end and the receiving end. Transmission signals injected from the transmitting unit 43 are attenuated by the low impedance circuit unit 25 inserted between the transmitting end and the receiving end, and therefore are not fed back to the receiving unit 41.

In the case where the signal couplers 21 to 24 are made solely from normal magnetic bodies, the signal coupler (ferrite core) size has to be several tens cm in order to couple signals while avoiding magnetic saturation along the power lines 10 where a large current flows. On the other hand, with the gaps 21a to 24a opened in the magnetic bodies (ferrite cores 21b to 24b) of the signal couplers 21 to 24 to let air, which has low magnetic permeability, inside the magnetic bodies, the overall magnetic permeability is lowered and therefore the necessary size of the magnetic bodies (ferrite cores 21b to 24b) is no larger than a few cm. However, opening the gaps 21a to 24a degrades coupling characteristics at low frequency. The frequency range of carrier wave signals is therefore set to 1 MHz or more and 50 MHz or less.

As is clear from the above description, the first embodiment makes the relay amplifying device installable without stopping the power lines 10 from feeding electric power since elements do not need to be inserted in series with the power lines 10. In addition, with the signal couplers 21 to 24 made as small in size as a few cm, the relay amplifying device can be set up in an idle space of a meter room or the like. This also makes the over-power line communication system applicable to a power line that has a large current capacity.

### Second Embodiment

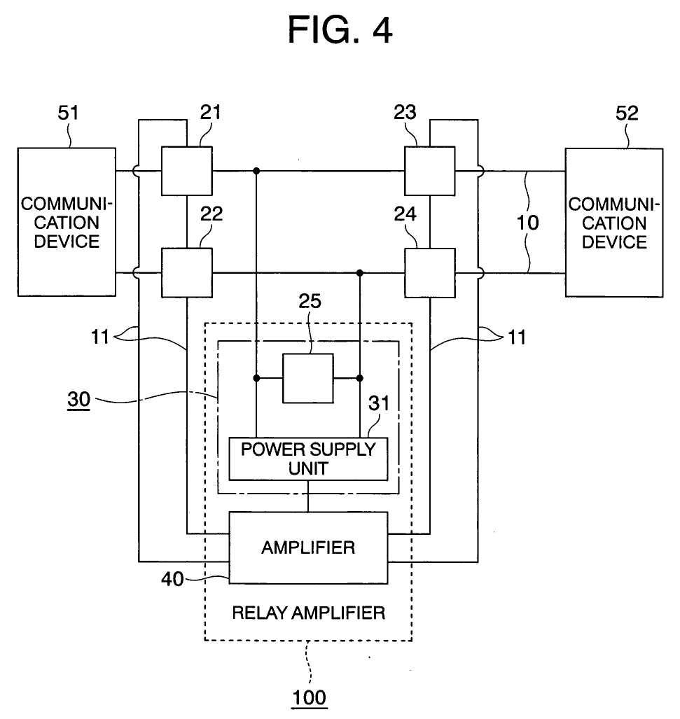

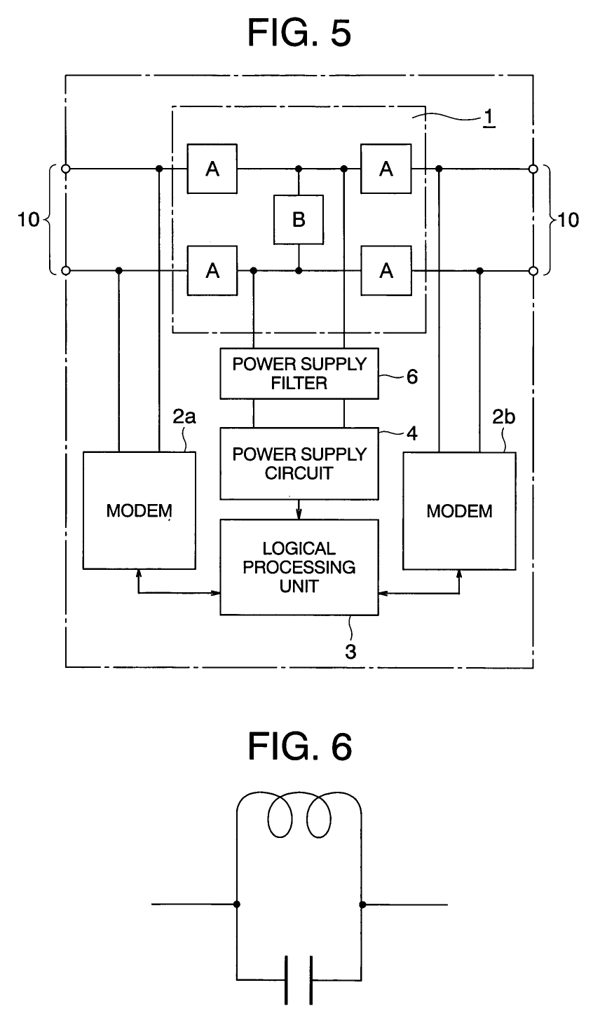

A description is given with reference to FIG. 4 on an over-power line communication system according to a second embodiment of the present invention. FIG. 4 is a block diagram showing a configuration of the over-power line communication system according to the second embodiment of the present invention.

In FIG. 4, a relay amplifying device of the over-power line communication system according to the second embodiment has four signal couplers 21, 22, 23, and 24, which electromagnetically couple power lines 10 with signal lines 11 between communication devices 51 and 52, and a relay amplifier 100, which amplifies transmission signals.

The relay amplifier 100 is composed of a power supply circuit 30, which is connected to the power lines 10, and an amplifier 40.

The power supply circuit 30 is composed of a low impedance circuit unit 25, which is connected between the two power lines 10, and a power supply unit 31, which is also connected between the power lines 10. The power supply unit 31 converts alternating current power supplied from the power lines 10 and having a given level of voltage into direct current power having a given level of voltage, and feeds the direct current power to the amplifier 40.

The amplifier 40 has, as described in the first embodiment, a receiving unit 41, which is connected to one of the signal lines 11, an amplifying unit 42, which is connected to the receiving unit 41, and a transmitting unit 43, which is connected to the amplifying unit 42 and to the other of the signal lines 11.

In the second embodiment, the low impedance circuit unit 25 to be inserted between the transmitting end and the receiving end is incorporated in the power supply circuit 30 of the relay amplifier 100 as shown in FIG. 4.

As is clear from the above description, the second embodiment in which the low impedance circuit unit 25 to be inserted between the transmitting end and the receiving end is incorporated in the power supply circuit 30, namely, the relay amplifier 100, makes the relay amplifying device installable by simply setting the signal couplers 21 to 24 of the relay amplifying device along the power lines 10 and supplying the power to the relay amplifier 100 (amplifier 40) from sections of the power supply lines 10 that are between the set signal couplers 21 to 24.

In addition, the second embodiment eliminates the need to connect, on site, the low impedance circuit unit 25, which is to be connected between the power lines 10, and thus improves the work efficiency in installing the relay amplifying device.

What is claimed is:

1. An over-power line communication system, comprising:
first and second communication devices connected to each other by two or more parallel power lines; and
a relay amplifying device placed between the first and second communication devices, for amplifying signals inputted from one of the first communication device and the second communication device after transmission through the power lines, and sending the amplified signals to the other one of the first communication device and the second communication device,
the relay amplifying device including:
an amplifier for amplifying inputted signals and outputting amplified signals;
first signal couplers for electromagnetically coupling a first signal line, which is connected to the amplifier, with the power lines on the first communication device side;
second signal couplers for electromagnetically coupling a second signal line, which is connected to the amplifier, with the power lines on the second communication device side; and
a low impedance circuit unit connected between sections of the power lines that are between the first and second signal couplers.

2. An over-power line communication system according to claim 1,
wherein the first signal couplers have first ferrite cores, which are hollow in their axial centers,
wherein the power lines and the first signal line are placed in the hollow axial centers of the first ferrite cores, and coupled with each other through electromagnetic coupling,
wherein the second signal couplers have second ferrite cores, which are hollow in their axial centers, and
wherein the power lines and the second signal line are placed in the hollow axial centers of the second ferrite cores, and coupled with each other through electromagnetic coupling.

3. An over-power line communication system according to claim 1, wherein a signal communicated over the power lines between the first and second communication devices has a carrier wave frequency of 1 MHz or more and 50 MHz or less.

4. An over-power line communication system according to claim 2, wherein a signal communicated over the power lines between the first and second communication devices has a carrier wave frequency of 1 MHz or more and 50 MHz or less.
